(19) United States
(12) Patent Application Publication
(10) Pub. No.: US 2012/0329030 A1
(43) Pub. Date: Dec. 27, 2012

(54) SYSTEM AND METHOD OF KNOWLEDGE ASSESSMENT

(76) Inventors: Dan Joseph Leininger, New Orleans, LA (US); Eric Jeffords Leininger, New Orleans, LA (US); Adam Garland, Melrose, MA (US)

(21) Appl. No.: 13/602,198

(22) Filed: Sep. 2, 2012

Related U.S. Application Data
(63) Continuation-in-part of application No. 12/657,910, filed on Jan. 29, 2010.

(51) Int. Cl. G09B 7/00

(52) U.S. Cl. 434/350; 434/362

(57) ABSTRACT

A system and method of knowledge assessment provides for a computer-executable program capable of generating a user's knowledge profile based on answers to queries posed to the user via a communication network. The user's knowledge profile can be used for creating a detail curriculum in a specific academic subject for the user to pursue or for comparing with the knowledge profile of one or more other users. The detail curriculum, or knowledge path, arranges the subjects to be learned in a hierarchical manner so that the user can determine which subject categories must be mastered before moving to other categories and concepts.

### CROSS-REFERENCE TO RELATED APPLICATIONS

This is a continuation-in-part application which claims the priority benefit of U.S. patent application Ser. No. 12/657,910.

### STATEMENT REGARDING FEDERALLY SPONSORED RESEARCH AND DEVELOPMENT

Not applicable.

### REFERENCE TO A “SEQUENCE LISTING APPENDIX”

Not applicable.

### BACKGROUND OF INVENTION

### Field of the Invention/Technical Field

This invention relates to an interactive educational system and method providing an enhanced computer-based assessment of a user's knowledge base within broad narrow fields of knowledge, as well as learning and testing modules. It also relates to a method and system for assessing the knowledge level of an individual within a specific field of knowledge and creating a defined curriculum for increasing the knowledge level within such specific field.

It is important in commerce to understand the extent of what business partners or employees know about specific fields of knowledge. For educational background, there are four gross representations of people's knowledge. They are, from broadest to most specific: 1) a degree from an educational institution pertinent to the field of study (including honors applied such as magna or summa cum laude), 2) the grade point average, usually a numerical scale from 0-4 depicting the average achievement among courses pursued, 3) grades among individual courses and ultimately 4) individual grades for tests or quizzes in courses. Currently the means by which one transmits one's own or others educational breadth is through the means of a resume, curriculum vitae, transcript from an educational institution, word of mouth, or (slowly) feedback based performance.

Incumbent among these traditional means is a large degree of non-specificity and variability which hamper both the transmitter of information about ones own knowledge breadth and the evaluator of this information. For example, when applying for employment, candidates are usually required to submit a resume with a broad swath of information, through which the intellectual competency of the candidate can be broadly ascertained. However, the inherent variability in teacher evaluations, courses proffered, and institutional reputation leaves the evaluator with only a broad notion of the educational competency relative to the requirements that are required for an employment position. The evaluator tasked with perusing numerous applications based on limited information can lose valuable candidates due to this variability and non-specificity. Similarly, the candidate him/herself may not be able to accurately represent the breadth of their own knowledge in such a consolidated and traditional form, which may be important for performing the required tasks for the applied position.

In addition, it is often necessary to compare the relative educational breadths of one to another in very specific subtopics. Currently, the traditional means listed above do not provide but more than a relative glance of one's educational breadth in specific fields. Rather conversation, for instance in an employment situation, and performance-based feedback, is utilized to evaluate ones field-specific knowledge. Both of these means are time consuming, variable in their accuracy, expensive, and the differences extant between those evaluated are hard to represent.

Because current means of knowledge representation for individuals is unreliable, when an individual wants to learn more about specific topics, the starting points and learning paths to the educational goals are ill-defined. Currently the means by which people learn about the paths of knowledge to specific topics is done by pursuing an educational curriculum. This is done broadly by the choosing of specific majors, which then entail necessary courses having detailed syllabi showing the curriculum. However, these current means has a number of deficiencies: First, the ability to evaluate many curriculums is slow. Second, traditional curriculums do not allow one to rapidly determine whether other individuals are interested in similar educational goals. Third, one is not able to create one's own curriculum based on interest of a very specific subtopic (for example, the means by which one can determine all the necessary knowledge topics in order to understand the function and use of a particular type of transistor). Fourth, there are no means by which traditional curriculums can define the specific educational prerequisites required to learn what another person knows (for example, a means by which Bob can determine all the necessary knowledge topics he should learn, in order to match what Jane knows about muscle physiology).

The present invention contemplates elimination of drawbacks associated with conventional systems and methods of knowledge assessment and provision of an interactive learning and testing system and method that overcomes the problems associated with prior art systems.

### SUMMARY OF THE INVENTION

It is, therefore, an object of the invention to provide a system and method of knowledge assessment and provision of an interactive learning and testing system for devising a curriculum of study within a designated knowledge field.

It is another object of the invention to provide an enhanced computer-based reference base for use as learning and testing tool.

It is still another object of the invention to provide an interactive testing system to assess a user's knowledge level in broad and narrow fields.

A further object of the invention is to provide an interactive learning and testing system in which each topic is provided with an objective rating of relative importance or difficulty.

It is yet another object of this invention to provide a system for efficiently and accurately testing user knowledge.

It is yet another object of this invention to incorporate user-generated learning modules into an interactive system. These modules are detailed in provisional patent applications, A METHOD AND SYSTEM FOR CREATING SHARABLE PURPOSE-SPECIFIC LEARNING MODULES 61/684,783 (hereby incorporated by reference) filed on Aug. 19, 2012 and A METHOD AND SYSTEM FOR CURIOSITY-BASED PEER TO PEER LEARNING 61/684,786 file on Aug. 19, 2012 (hereby incorporated by reference).

It is another object of the invention to provide a system capable of generating unique curriculums for learning a specific topic within a designated academic subject or field. These and other objects of the invention are achieved through provision of a system for knowledge assessment adaptable for use in a processor based computing device and in a networked communication environment. The system comprises a programmable computer processor, in input device capable of communicating with the processor via a communication network, a display device operationally connected to the processor and the input device. The system also comprises a group of databases including knowledge database of academic subjects and a database of assessment queries related to the academic subjects stored and retrievable in the processor.

A query builder is capable of constructing a set of queries to be answered by the users in one or more academic subjects. A knowledge profile creator is capable of creating knowledge profile of the users while processing answers by the users to the questions constructed by the query builder. A visual image creator creates a graphic image of the knowledge profile of one or more users within the context of the knowledge database. The processed data can be used to compare knowledge profiles of two or more users based on their answers to the queries and within the context of the academic knowledge database.

The processed data can also be used for generating a knowledge path, or detail curriculum in a selected academic field, which the user desires to pursue. The generated detail curriculum can be arranged in a hierarchical manner

Other important objects and features of the invention will become apparent to one of ordinary skill in the art in view of the descriptions that follow.

### BRIEF DESCRIPTION OF THE DRAWINGS

Reference will now be made to the drawings, wherein like parts are designated by like numerals, and wherein

FIG. 1 is schematic flow chart of the system of the present invention.

FIG. 2 illustrates the first step a user performs according to the method and system of the present invention.

FIG. 3 graphically illustrates a user's knowledge profile generated by a computer in the method and system of the present invention.

FIG. 4 graphically illustrates a step in the method where the user's knowledge profile is evaluated in the context of collective knowledge.

FIG. 5 graphically illustrates an interactive step where the user's knowledge profile is evaluated within the context of five core knowledge categories.

FIG. 6 graphically illustrates an interactive step where the user's knowledge profile is evaluated within the context of an exemplary core knowledge category of Formal Sciences.

FIG. 7 graphically illustrates an interactive step where the user's knowledge profile is evaluated within the context of an exemplary knowledge area of mathematics.

FIG. 8 graphically illustrates an interactive step where the user's knowledge profile is evaluated within the context of a knowledge area of a subject sub-category.

FIG. 9 graphically illustrates an interactive step where the user's knowledge profile is evaluated in a detail area of subject core concepts.

FIG. 10 graphically illustrates an interactive step where the user's knowledge profile is compared with the knowledge profile of another individual in broad categories of knowledge base.

FIG. 11 graphically illustrates a step in the method where the user's knowledge profile is compared with the knowledge profile of another individual against the context of collective knowledge.

FIG. 12 graphically illustrates a step in the method where the user's knowledge profile is compared with the knowledge profile of another individual within the context of five core knowledge categories.

FIG. 13 graphically illustrates a step in the method where the user's knowledge profile is compared with the knowledge profile of another individual within the context of an exemplary core knowledge category of Formal Sciences.

FIG. 14 graphically illustrates a step in the method where the user's knowledge profile is compared with the knowledge profile of another individual within the context of an exemplary knowledge area of mathematics.

FIG. 15 graphically illustrates an interactive step where the user's knowledge profile is compared to the knowledge profile of another individual within the context of a knowledge area of a subject sub-category.

FIG. 16 graphically illustrates an interactive step where the user's knowledge profile is compared to the knowledge profile of another individual in a detail area of subject core concepts.

FIG. 17 graphically illustrates an interactive step where the user's personal curriculum is created in a specific subject.

FIG. 18 graphically illustrates an interactive step where the user can compare the user's personal curriculum to the collective knowledge in the specific subject.

FIG. 19 graphically illustrates an interactive step where the user compares the user's curriculum within the context of five care knowledge categories.

FIG. 20 graphically illustrates an interactive step where the user compares the user's curriculum within the context of a specific subject of Neuropsychology.

FIG. 21 graphically illustrates an interactive step where the user compares the user's curriculum within the context of a specific subject of mathematics in the specific area of Neuropsychology.

FIG. 22 graphically illustrates an interactive step where the user compares the user's curriculum with the knowledge base divided into sub-concepts in the specific subject.

FIG. 23 graphically illustrates an interactive step where the user compares the user's curriculum with the required curriculum in the exemplary subject of Neuropsychology.

FIG. 24 graphically illustrates an interactive step where the user compares the user's knowledge profile and the user's curriculum and identifies the subjects necessary to achieve an educational goal.

FIG. 25 graphically illustrates an interactive step where the user compares the user's knowledge profile and the user's curriculum and identifies the subjects necessary to achieve an educational goal.

FIG. 26 graphically illustrates an interactive step where the user compares the user's knowledge profile and the user's curriculum and identifies the subjects necessary to achieve an educational goal.

FIG. 27 graphically illustrates different steps that may be used to create a knowledge base.

FIG. 28 graphically illustrates different steps that may be used to create assessment queries.

FIG. 29 graphically illustrates different graphical user interfaces of potential ways to identify core concepts in the knowledge base.

FIG. 30 graphically illustrates different types of algorithms that may be used to generate a knowledge path.

### DETAIL DESCRIPTION OF THE INVENTION

This invention is designed to increase the ability of persons to evaluate theirs or another's breadth of knowledge, compare ones knowledge to another and create self-defined curriculums, in a simple interactive visual format. The interactive nature of the invention both allows one to grossly assay and transmit their broad educational background and also examine very specific subtopics of one's knowledge. This allows both the evaluator and transmitter of information to more rapidly ascertain/present a more accurate evaluation of the breadth of one's knowledge, allowing a more correct determination of the breadth of one's knowledge than is currently available (for example, when an employer is examining applications for hiring, he/she would have more accurate information regarding the specific subtopics of knowledge unique to individual applicants). In addition, this invention allows rapid comparison of one's own knowledge with one or more persons from very broad topics down to very specific subtopics and allows one to rapidly evaluate and create curriculums with self-defined destinations.

In this description, the term “knowledge horizon navigator” refers to an interactive tool designed to zoom in and out of a “circle of knowledge” subscribed by a “knowledge horizon.” All areas within the circle of knowledge represent the collective knowledge, while the area outside of the circle of knowledge relates to “the unknown.” The term “knowledge path” refers to a personal curriculum created in a specific subject.

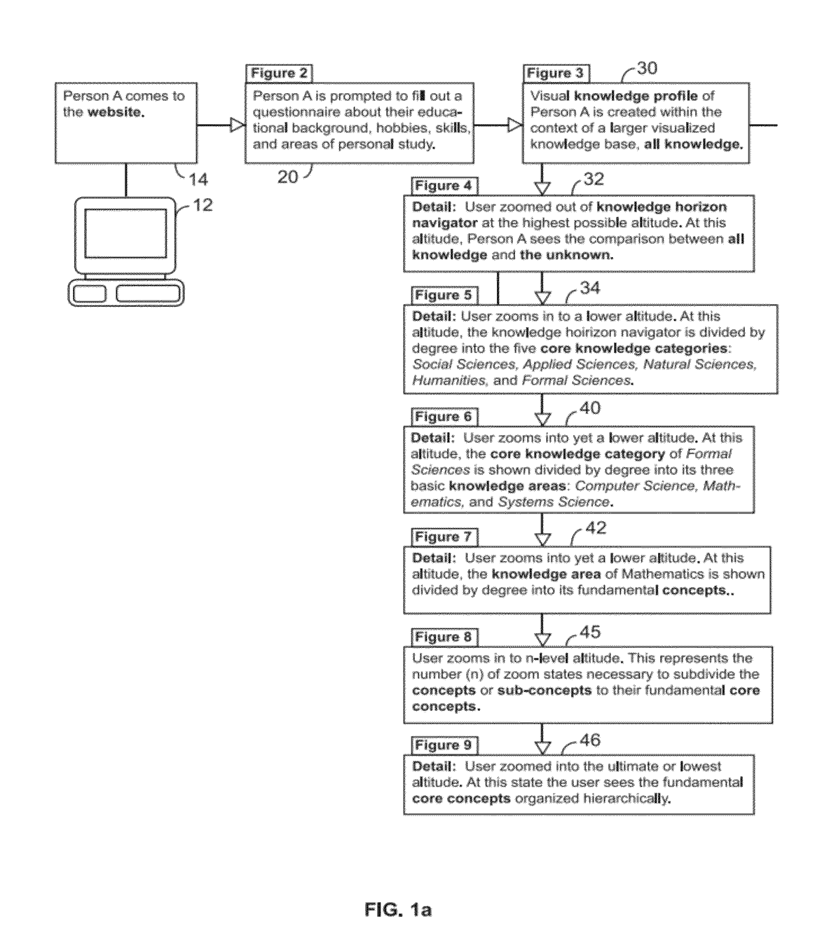

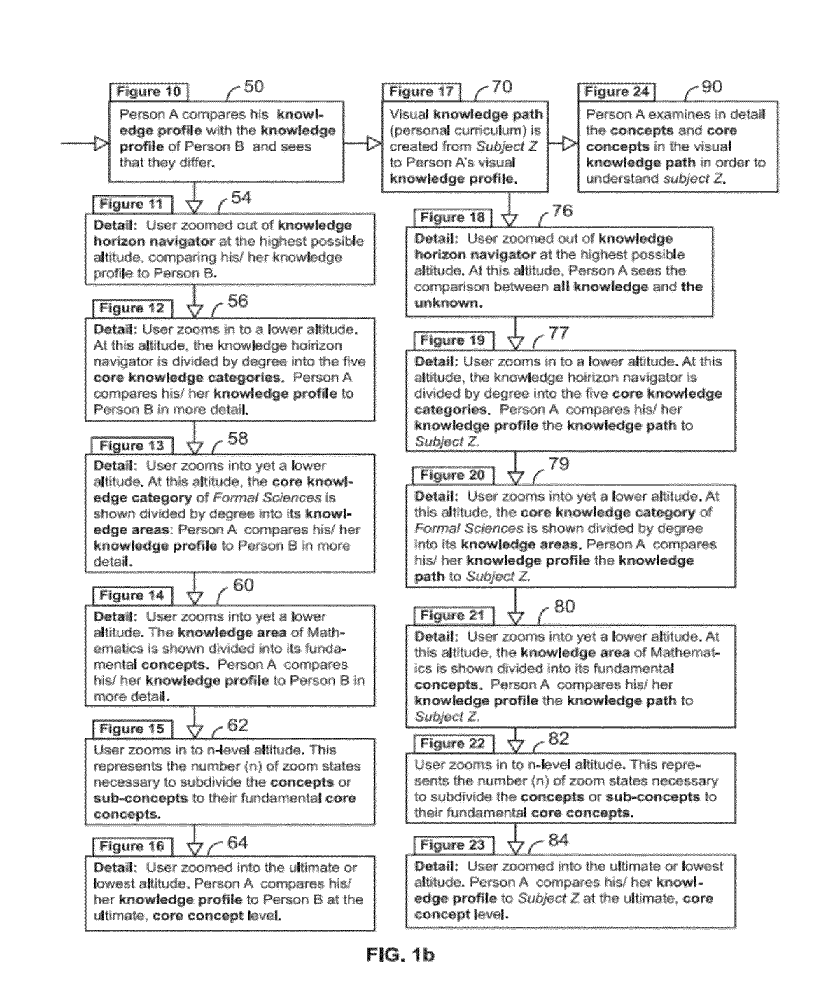

In accordance with this invention, FIG. 1 depicts a process flow associated with the system of knowledge assessment. The steps of the method, such as a step of transmitting to one or more user a plurality of assessment queries and of receiving answers to the assessment queries are both implemented via a microprocessor based computing device or a networked client-server communication system. The method of the instant system is conducted using a proprietary software program and a microprocessor-based CPU 12 with the installed knowledge assessment system. It will be understood that the CPU may be accessed either directly or through a remote connection 14, such as a remote computer network. A web deployed e-learning knowledge assessment system for remote evaluation of users' knowledge base and development of the user-specific curriculum is provided for implementation of the method of this invention. The interactive program is capable of generating visual images displayed on a computer monitor, guiding the user step-by-step during the process.

A monitor is connected to the CPU 12 to allow display of visual information and images generated by the interactive module uploaded into the CPU 12. An input device, such as a keyboard connected to the processor 12 allows interactive communication between the user and the processor.

The method comprises five major architectural blocks, or steps: the first step 20 involves user's input, where the user is prompted to fill out a questionnaire about the user's educational background, hobbies, skills, and areas of personal study. The second major block 30 involves several steps, when the information generated in step 20 is processed using the computer algorithm, and then a graphical representation of the user's knowledge profile within a larger graphically represented knowledge base is generated.

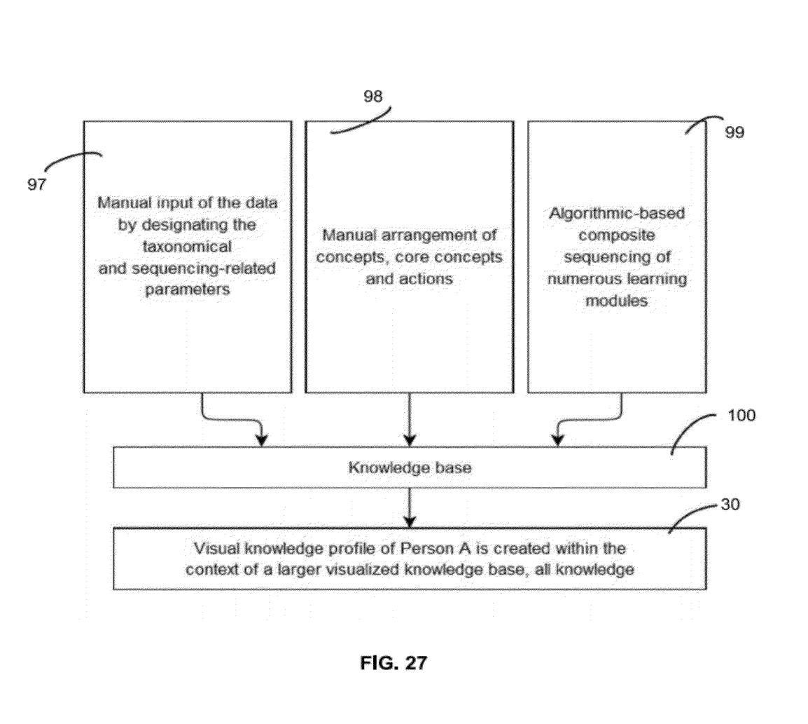

It is contemplated that this knowledge base 100 can be generated from many sources. FIG. 27 shows an example of three different ways by which a the knowledge base may be generated. In one embodiment of this invention there could be simple manual input of the data by designating the taxonomical and sequencing-related parameters 97. In another embodiment there could be an manual input of concepts, core concepts and actions 98 as in international patent application PCT/US11/2261. Here “manual input” is meant to indicate data entry by a nominal graphical user interface with input fields for the required data. The knowledge base is populated by input to a cpu connected to a monitor and is stored on one or more readable/writable computer memory components such as but not limited to a hard drive or flash drive. In yet another embodiment the knowledge base could be generated by the manual input or algorithmic-based composite sequencing of numerous learning modules 99 as in application A METHOD AND SYSTEM FOR CREATING SHARABLE PURPOSE-SPECIFIC LEARNING MODULES 61/684,783.

The third major block 50 contains several steps, when a visual profile of the user is compared to a visual profile of another person. The fourth major block 70 provides for the steps of creating the user's knowledge path, or personal curriculum within the goal of identifying specific subjects that the user should master to obtain a degree or substantial knowledge in a particular subject area. The final major block 90 provides for the user's review of the generated personal curriculum containing concepts and core concepts in the knowledge path to understand the defined subject area.

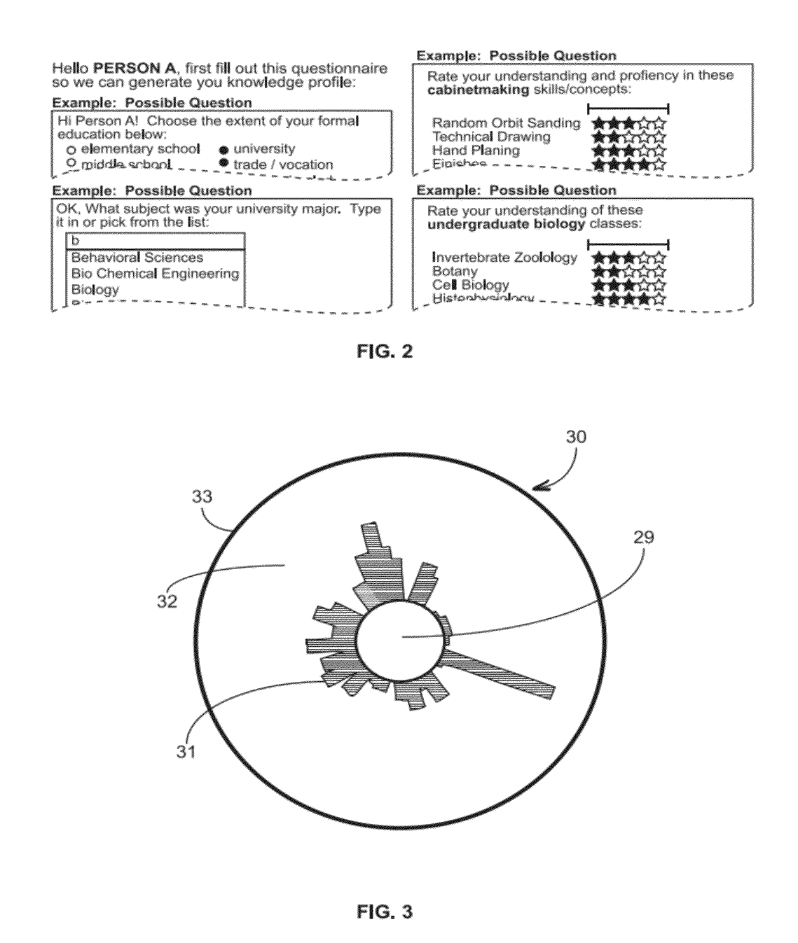

FIG. 2 is a detail view of a step, during which the system transmits the assessment queries related to the user's educational background and acquired knowledge. In the step 20 the user fills out one or more questionnaire tables. The computer program embodied in a computer-readable medium prompts the user to answer a series of questions related to his educational background, skills, etc. A fragment of a questionnaire is shown in detail in several exemplary queries, such as the extent of the formal education, any degree obtained, skills in cabinetmaking, the area of undergraduate study, etc. It will be understood that numerous variations of the questionnaire can be created using the computer program of this invention. In the example shown in FIG. 2, the user, “Person A,” has graduated from the university with a major in Biology and a vocational school with a focus on Cabinetmaking.

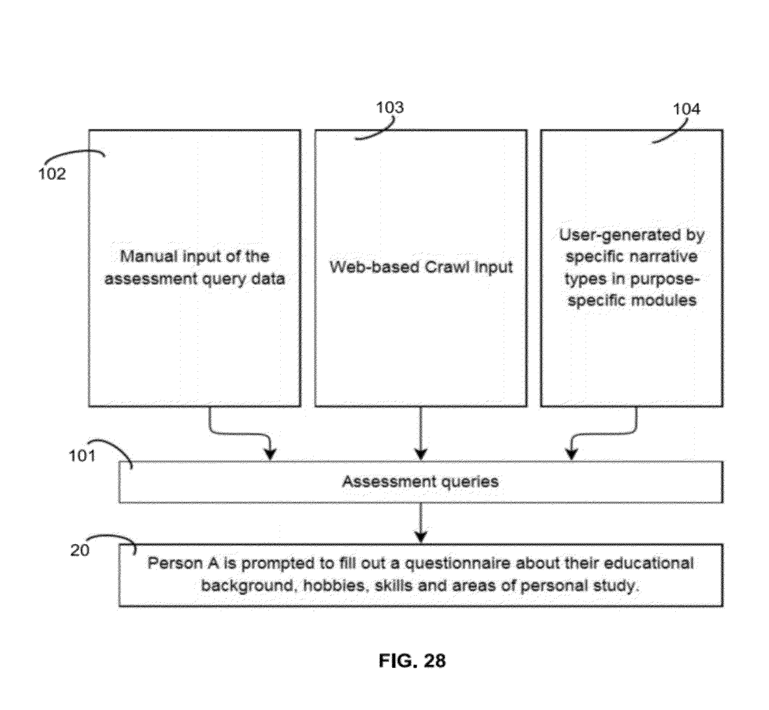

It is contemplated that the assessment queries 101 can be generated by multiple means as seen in FIG. 28. In one embodiment 102 the queries can be manually input into the systems database referenced by their taxonomic fields . In another embodiment 103 the queries can be computer generated by a web-based crawl similar to a Google crawler that indexes web pages. Here, specific parameters are used to filter text as “a query” that is related to a specific taxonomy and these queries can be input into the systems database. In yet another embodiment 104 the queries can be user-generated by specific narrative types in purpose-specific modules as in A METHOD AND SYSTEM FOR CREATING SHARABLE PURPOSE-SPECIFIC LEARNING MODULES 61/684,783 and A METHOD AND SYSTEM FOR CURIOSITY-BASED PEER TO PEER LEARNING 61/684,786. The assessment queries are stored on one or more readable/writable computer memory components such as but not limited to a hard drive or flash drive via connection to a cpu. For example, learning modules with the Bloom Narrative in application 61/684,786 are queries that can be related to the user's designation of a knowledge subject. The query-based narratives such as a the Bloom Narrative can be extracted from multiples of these learning modules and used for knowledge assessment.

Once the user completes the questionnaire in step 20, the computer algorithm translates the answers into an interactive hierarchical graphical representation of the user's knowledge (“knowledge profile”) overlaid on a graphical representation of a larger visualized knowledge base (“all knowledge”). As can be seen in FIG. 3, the major step 30 shows the knowledge profile 31 of the user clustered within a larger field of “all knowledge.” The all knowledge” field is defined by “knowledge horizon” circle 33. The area outside the circle 33 is “the unknown.”

The major block 30 comprises several steps, including a step 32 of zooming out of the knowledge horizon navigator to the highest “altitude,” as graphically illustrated in FIG. 4. In the step 32, the user can visually apprehend the extent of the collective knowledge and the user's knowledge 31. The radius of the circle of knowledge represents the complexity and time required to learn a particular topic. Less complex subjects, such as for instance arithmetic, lie toward the center 29 of the circle 33, while more complex topics (those with many prerequisite concepts of understanding) such as for instance linear algebra are located closer to the circumference.

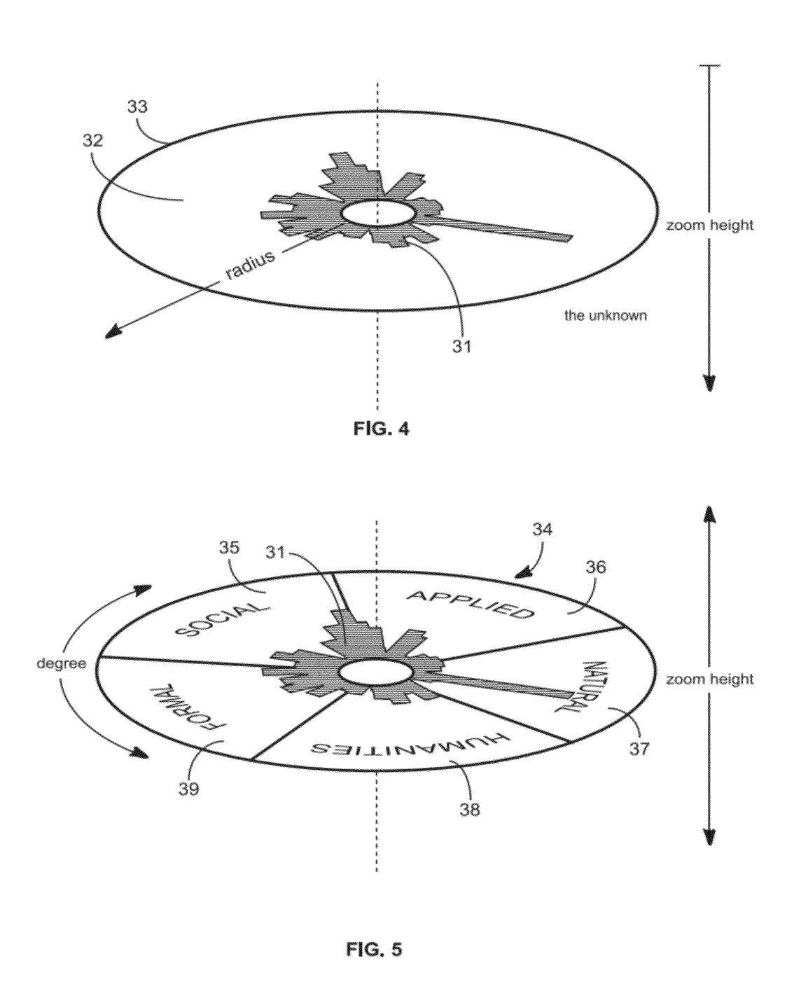

The next step 34 in the major block 30 allows the user to zoom in to a lower altitude using the knowledge horizon navigator of the present system. In this step, the program divides the knowledge base required for a specific degree into five core knowledge categories or segments: social sciences segment 35, applied sciences segment 36, natural sciences segment 37, humanities segment 38, and formal sciences segment 39. As can be seen in FIG. 5, the zoom height can be selected by the user, and a degree, which the user seeks to obtain, can be moved between the core segments of knowledge.

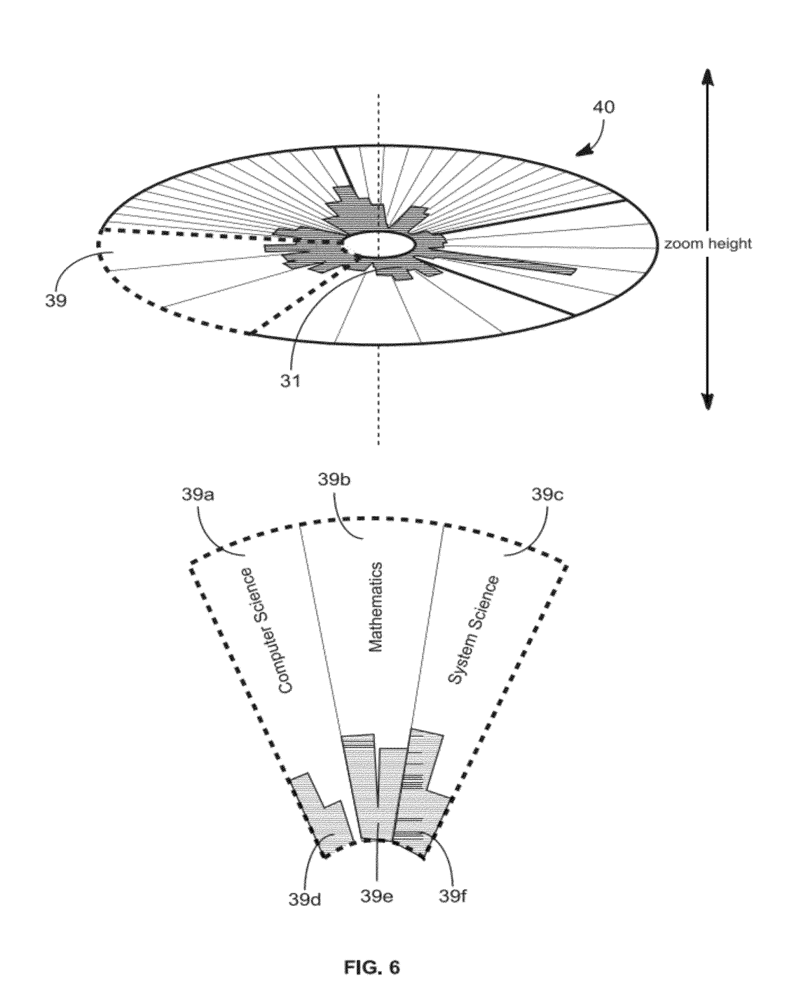

FIG. 6 illustrates the next step 40 in the process of generating the user's profile. At this step, the user zooms to a lower altitude and is guided to operate within a specific core knowledge category. In the example shown in FIG. 6, the user can view a specific segment of core knowledge category of formal sciences, which is subdivided into basic knowledge areas, or subdivisions: computer sciences 39a, mathematics39b, and systems science 39c. The subdivisions 39a, b, and c, each contain a shaded area, 39d, 39e, and 39f, respectively, which correspond to the knowledge areas of the user.

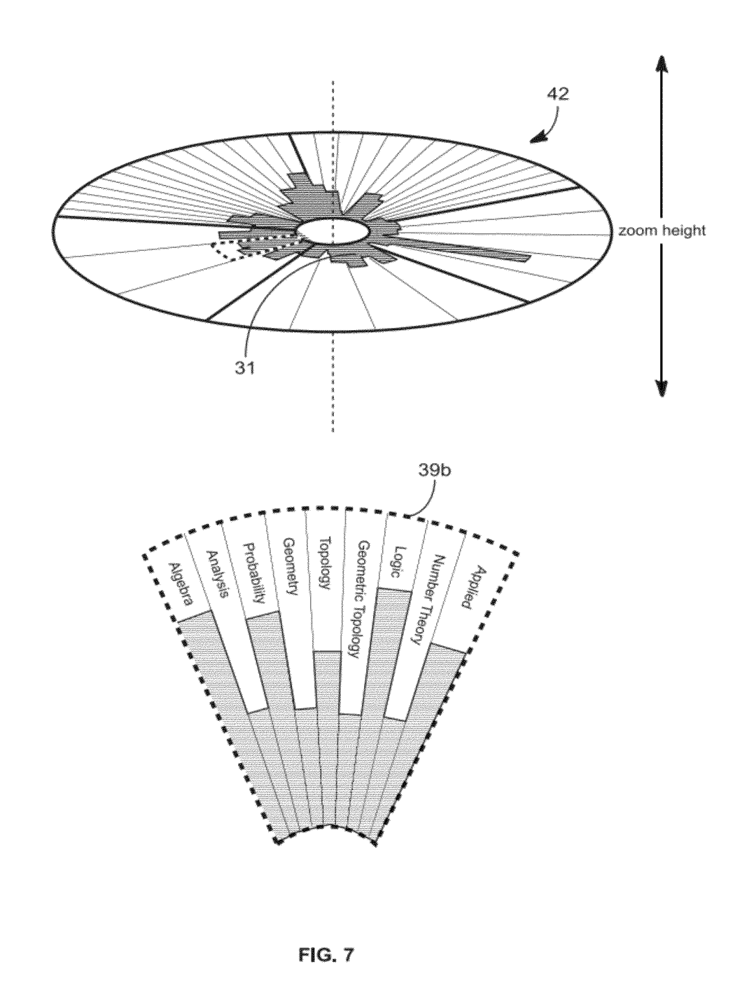

The user's knowledge can be further detailed in a step 42 (FIG. 7), where the computer displays further details of the user's knowledge within a particular subdivision of mathematics (subdivision 39b). Within this particular subdivision, the knowledge base is further subdivided into several fundamental concepts, such as algebra, analysis, probability theory, logic, etc. The user's knowledge profile is represented by the shaded area of small segments within the subdivision 39b.

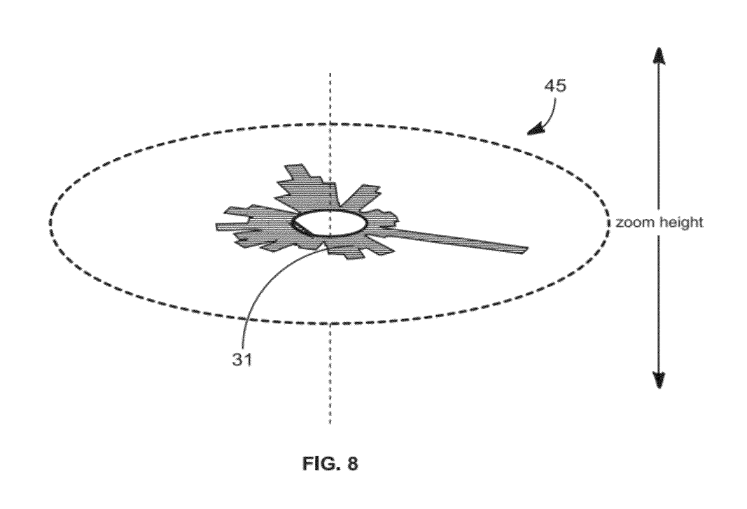

The architectural block 30 comprises an optional selectively chosen further step 45, schematically illustrated in detail FIG. 8. At this step, the user operates the CPU to zoom in to a defined level n, where the user can see visual representations of the concepts, subdivisions and sub-concepts in a fundamental core concept.

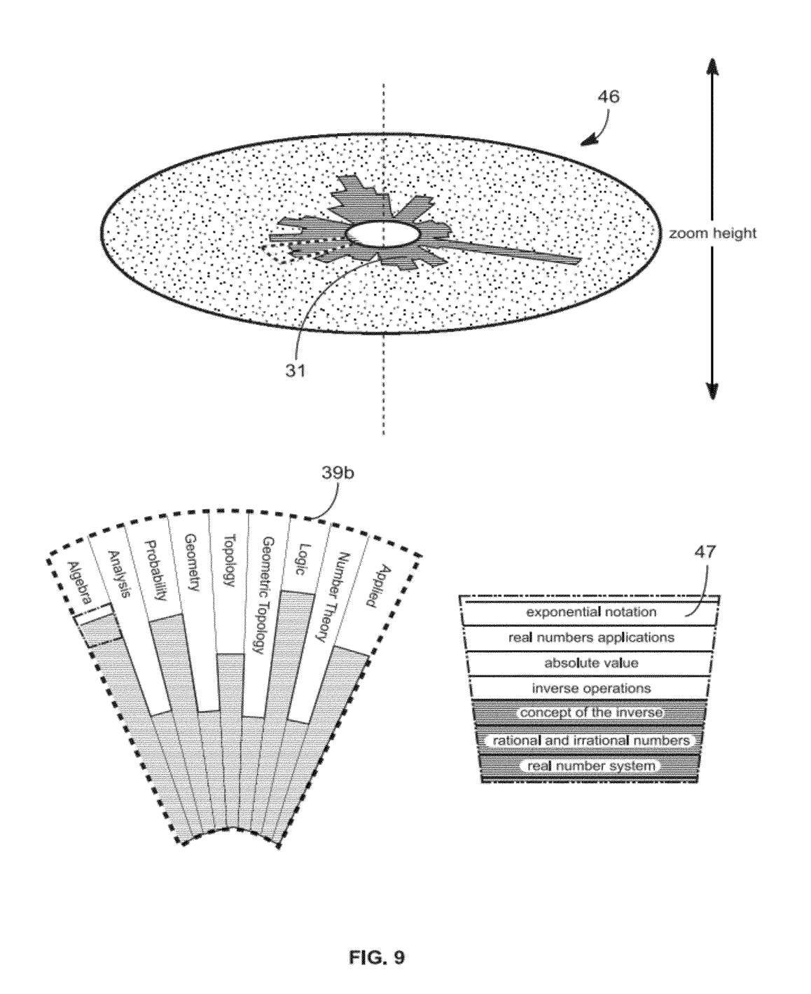

The user can also selectively move to a step 46, shown in detail in FIG. 9, where the user can zoom in to the lowest altitude to learn the fundamental core concepts that are included in hierarchical manner, from broader concepts to the narrow core concepts. In the exemplary illustration of FIG. 9, the user's knowledge profile is designated by the shaded areas. In this illustration, the user has knowledge of such core concepts in the subject of algebra as inverse operations, real number system, etc. The user does not posses the knowledge of the core concepts of exponential notation, real numbers, absolute value, etc.—the concepts shown in non-shaded areas of the detail table 47 in FIG. 9.

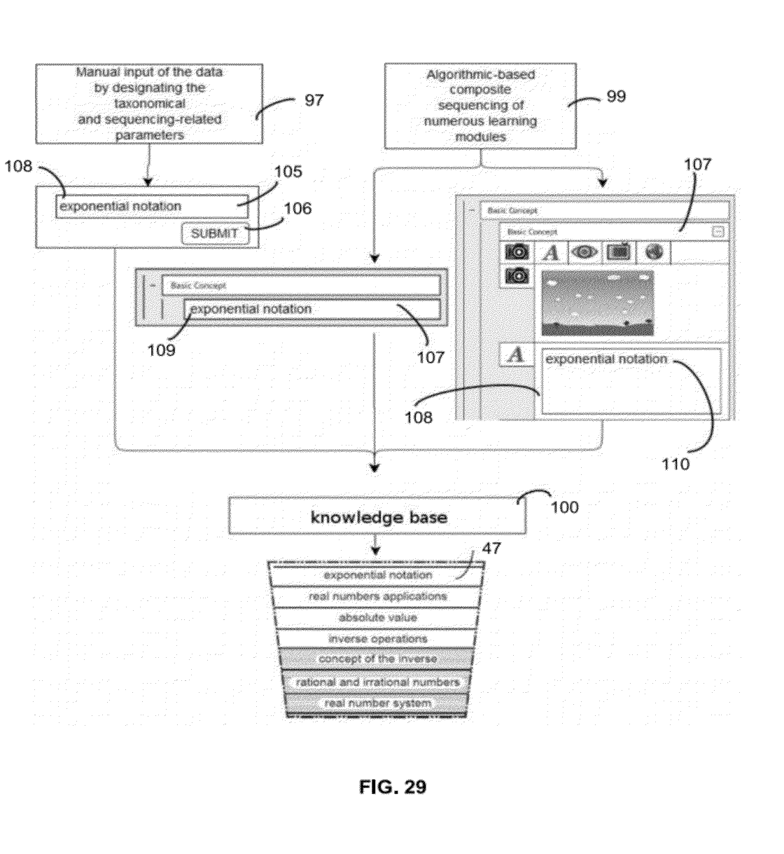

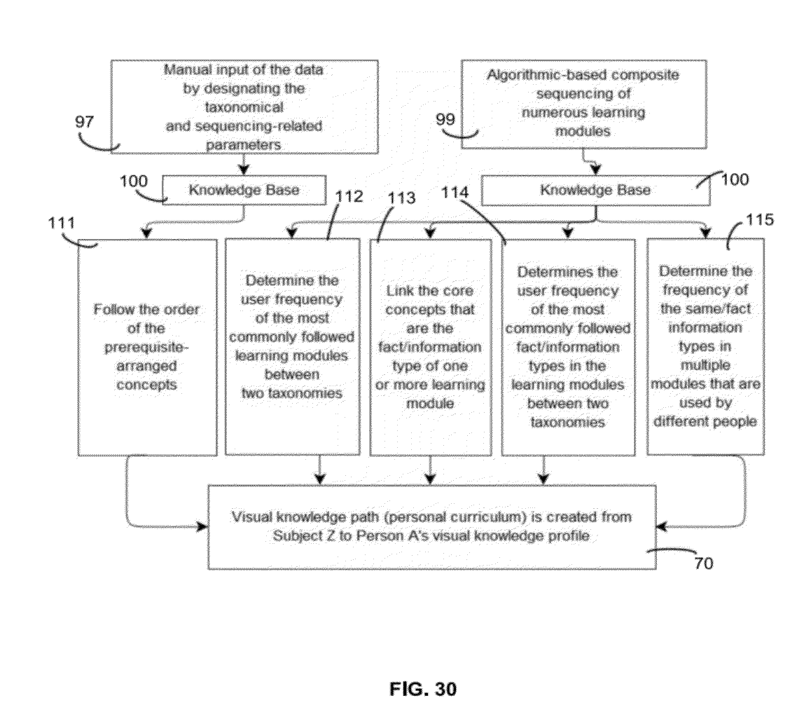

It is contemplated that the core concepts can be derived from multiple sources in the knowledge base 100 as seen in FIG. 29. In the case of manual method 97 of input into a knowledge base 100, the core concepts could be text of a particular concept type. In FIG. 30 there is an embodiment of a graphical user interface wherein the core concept is text 108 that is input into a text field 105 and submitted via an input button 106 into the knowledge base 100. In FIG. 30 is another embodiment wherein input into the knowledge base 100 is done by the module input method 99. Here, in an embodiment of a graphical user interface wherein the core concept is the text 109 of a nested descriptor 107 in a learning module as in A METHOD AND SYSTEM FOR CREATING SHARABLE PURPOSE-SPECIFIC LEARNING MODULES 61/684,783. In yet another embodiment wherein input into the knowledge base 100 is done by the module input method 99, the core concept could be the text 110 of a fact/information type 108 of a learning module as in A METHOD AND SYSTEM FOR CREATING SHARABLE PURPOSE-SPECIFIC LEARNING MODULES 61/684,783. In yet another embodiment the core concepts could be both nested descriptors and the fact/information type of a learning module.

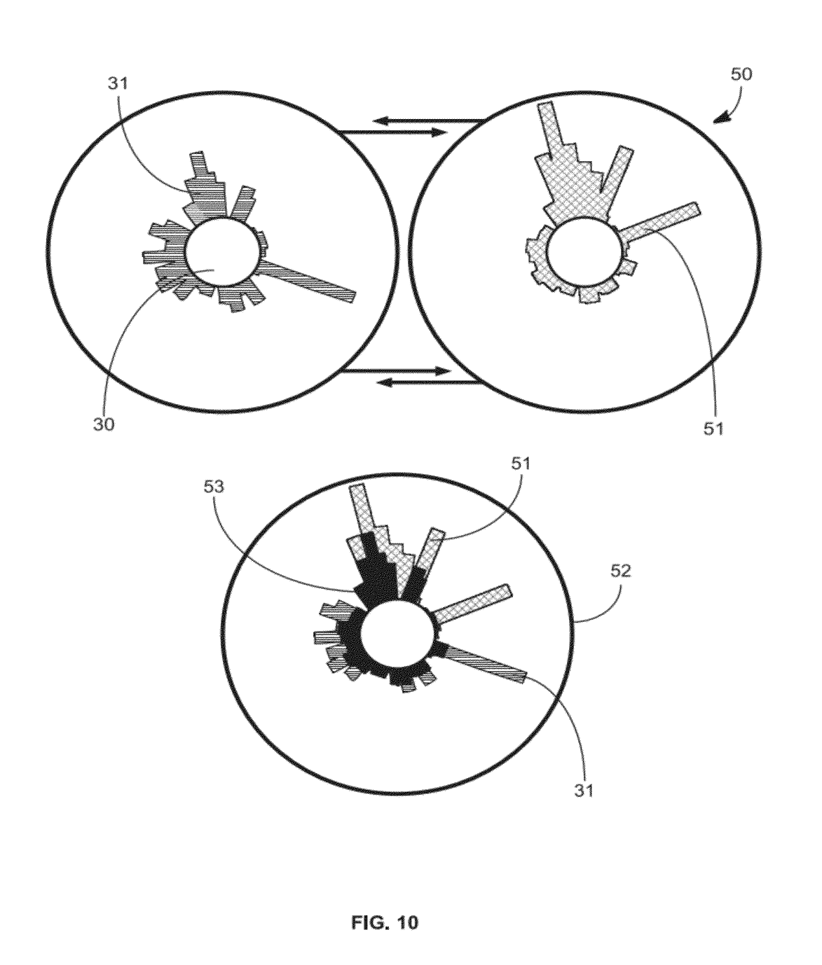

The architectural block 50 of the process contains several steps that allow the user to compare his/her knowledge profile with the knowledge profile of another person in the same or similar knowledge path. This imaginary individual is referred here for the purposes of simplification as “Person B.” The computer program of this invention generates an image shown in detail in FIG. 10 that contains the knowledge profile 30 of the user and knowledge profile 51 of Person B. The knowledge profile 51 can be selected by the user from a list stored in a remote central database. The knowledge profile 51 can be selected based on location, name, career path and other suitable criteria.

The program of the instant invention is also capable of generating an image 52 where the user's knowledge profile 31 is overlaid onto the knowledge profile 51 of Person B. In this illustration, the user's knowledge profile is lightly shaded; the knowledge profile of Person B is darker shaded; and the overlap 53 of the knowledge profiles 31 and 51 has the darkest shading.

The software is capable of performing a step 54 by generating a detail image shown in FIG. 11, where the user zooms out of the knowledge horizon navigator to the highest possible altitude when comparing the user's knowledge profile 31 with the knowledge profile 51 of person B. In this step, the software generates an image wherein the comparative knowledge bases 31 and 51 are represented in the context of the collective knowledge 32 contained within the knowledge horizon circle 33.

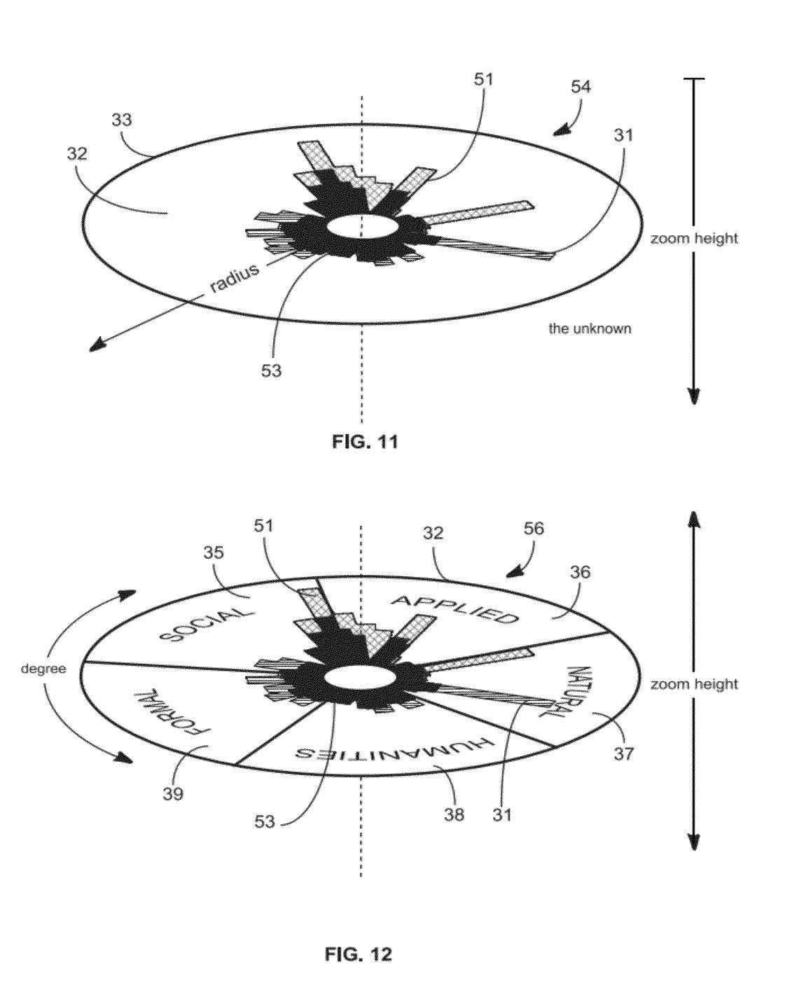

FIG. 12 illustrates a step 56, which allows the user to compare the user's knowledge profile with the profile of Person B in the context of five core knowledge categories: social sciences, applied science, natural sciences, humanities and formal sciences. The segments 35-39 of the knowledge circle 32 are overlaid with the shaded area 31 representing the user's knowledge profile and darker shaded areas 51, representing Person B′s knowledge profile. Where the knowledge base of the user and the knowledge base of person B overlap the shaded areas are the darkest. In the visual presentation of FIG. 12, the exemplary overlap illustrates that the user has more knowledge in the core knowledge category of humanities and formal sciences than person B, but Person B has more overall knowledge of natural sciences, humanities and applied sciences.

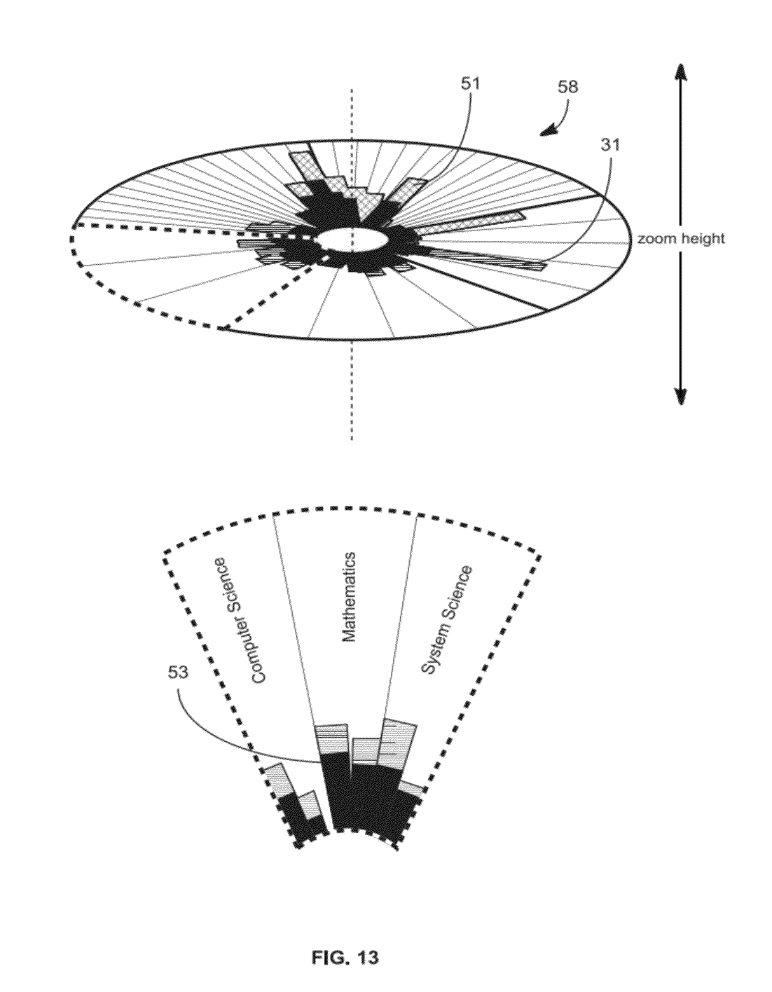

The user can also perform an optional step 58 of comparing the user's knowledge in one or more core categories, such as for instance formal sciences, with the knowledge profile of Person B. In the exemplary illustration in FIG. 13, the formal sciences, is shown divided into sub-categories of computer sciences, mathematics, and system sciences. In this example, the user has more knowledge of computer science, mathematics and system science than person B. The schematic shading 31 designating the user's knowledge overlaps the shaded areas 51 of Person B′s knowledge profile in the detail view in FIG. 13.

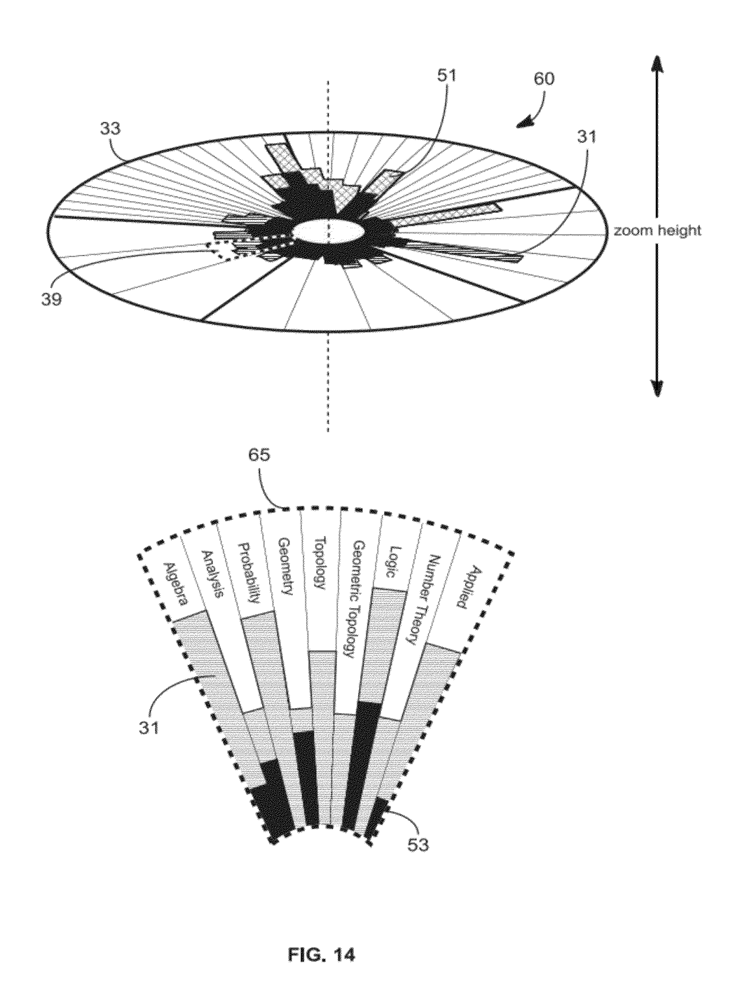

Using the same program and navigating to a still lower altitude allows the user to see an illustration of how the user's knowledge base compares to the knowledge base of person B in a more specific subject. The illustration of FIG. 14 graphically illustrates step 60, which allows the user to evaluate his knowledge base, as compared to the knowledge base of person B, in such sub-concepts of mathematics as algebra, analysis, geometry, logic, etc. In this example, the detail view in FIG. 14 the user has more knowledge in all sub-concepts of mathematics than person B.

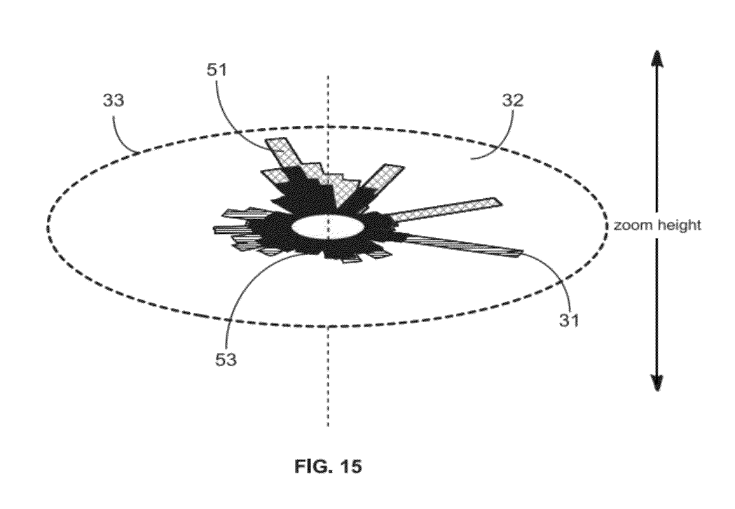

In the illustration of FIG. 15, the user can perform a step 62, which allows the user to zoom to an n level. This level represents the number of zoom states necessary to subdivide the concepts into fundamental core concepts and compare user's knowledge base with that of Person B.

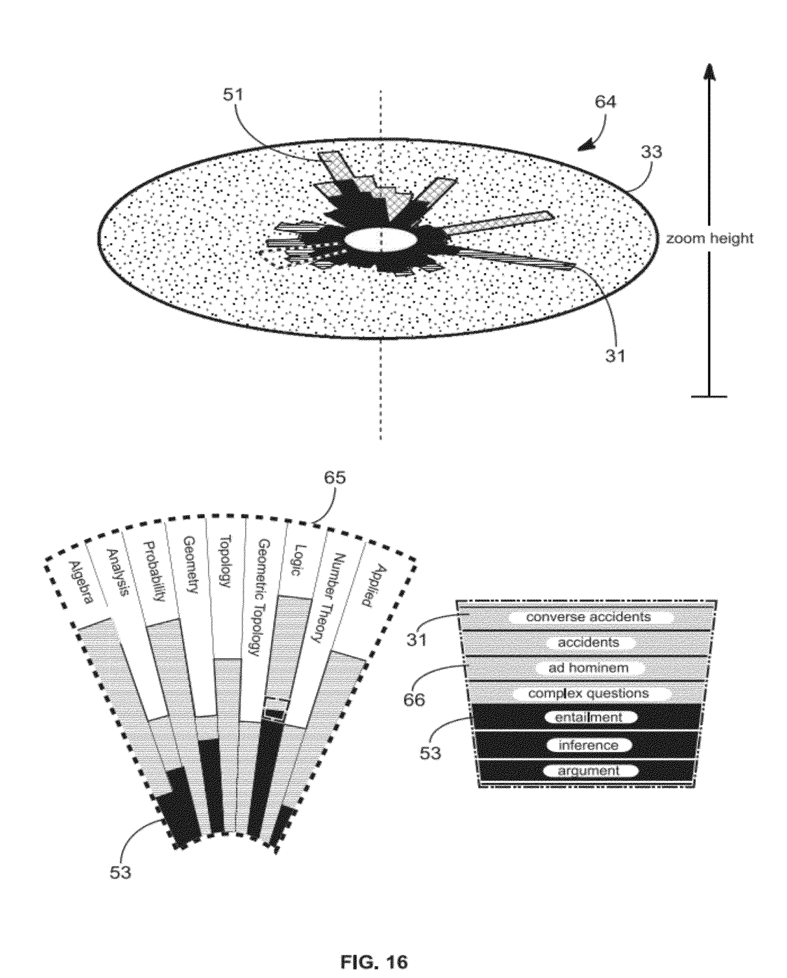

Another optional step 64 illustrated in FIG. 16 allows the user to compare the user's knowledge profile with the knowledge profile of Person B at the lowest “altitude,” where the core concepts are organized hierarchically by core concepts. In the detail table 65, the core concepts of mathematics are compared similar to the step 60. However, an additional image is generated, as shown in table 66, where hierarchical structure of one of the core concepts, for instance Logic, is broken down into sub-concepts, such as converse accidents, complex questions, etc. In the exemplary illustration of FIG. 16, the user's knowledge base 31 overlaps the core concepts that person B mastered, such as inference, argument, etc. Person B still needs to learn other sub-concepts in the study of Logic.

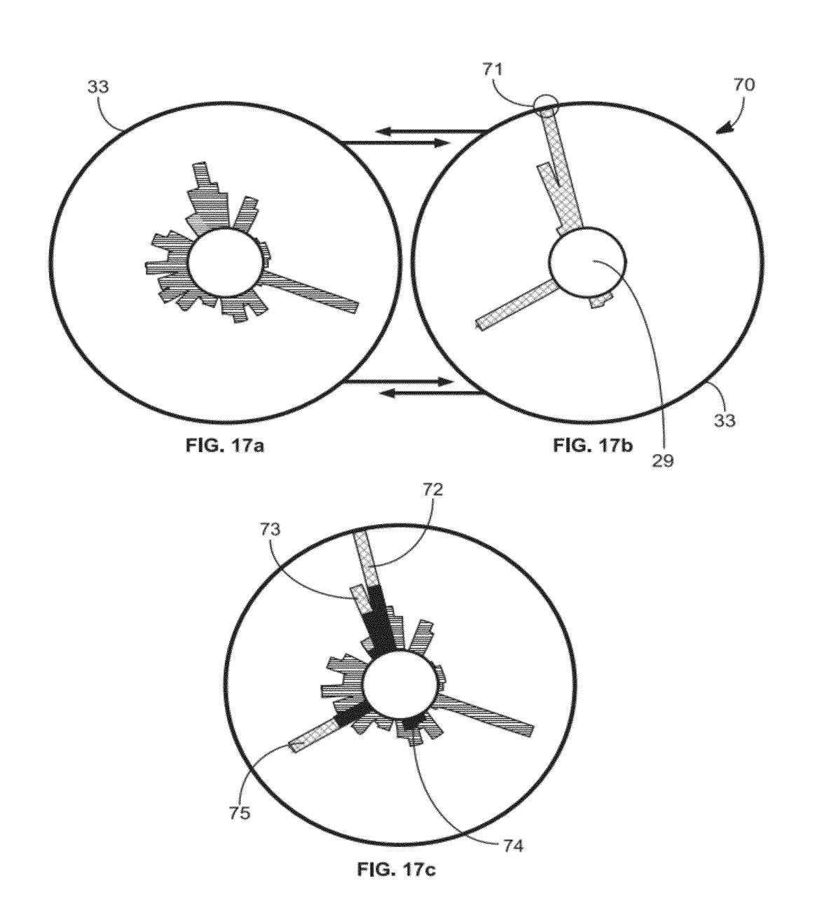

FIG. 17 illustrates the block of steps 70 when the personal curriculum, or knowledge path in a specific subject, for instance Neuropsychology, is generated. In this step, the program uses the data input of step 20 (FIG. 17a) to create the curriculum based on the user-selected knowledge path (FIG. 17b). The computer algorithm determines all of the core concepts that exist as prerequisites (closer to the center 29 of the knowledge circle 33) to the selected subject/degree and highlights then on the knowledge horizon navigator. In the illustrative example of FIG. 17b, the user can determine what the user needs to learn in order to understand the latest discoveries in the selected subject, for instance neuropsychology. The shaded area 71 in FIG. 17b represents the topics the user can learn from scholarly publications, magazines, etc. The user can “zoom in” on this particular core concept, and see the names of the publications and other works, which lead on the knowledge path to learning the latest developments in the chosen subject.

It is contemplated that the algorithm that creates the knowledge path can be created by many different means as shown in FIG. 30. For example, if the knowledge base 100 is generated by the manual input method 97 a simple algorithm 111 that follows the order of the prerequisite-arranged concepts that make up the knowledge base 100 in between two concepts, can be used to generate the knowledge path 70. If the knowledge base 100 is generated by the compilation of user-generated learning modules 99 than there are several example simple algorithms that would allow generation of a knowledge path 70. For example one algorithm 112 that makes up the knowledge path 70 is one that determines the user frequency of the most commonly followed learning modules between two taxonomies and than sequences one or more user-generated learning modules, which than function as the knowledge path. These learning modules are detailed in A METHOD AND SYSTEM FOR CREATING SHARABLE PURPOSE-SPECIFIC LEARNING MODULES 61/684,783. In yet another embodiment another algorithm 113 links the core concepts that are the fact/information type of one or more learning module as in A METHOD AND SYSTEM FOR CREATING SHARABLE PURPOSE-SPECIFIC LEARNING MODULES 61/684,783. In yet another embodiment, another algorithm 114 that makes up the knowledge path can be one that determines the user frequency of the most commonly followed fact/information types in the learning modules between two taxonomies and than sequence these fact/information types which than function as the knowledge path. In another embodiment, another algorithm 115 that makes up the knowledge path can be one that determines the frequency of the same/fact information types in multiple modules that are used by different people. After determining this, than one can sequence these fact/information types which than function as the knowledge path.

FIG. 17c is generated by the computer algorithm when the knowledge path of the user is overlaid onto the knowledge profile of the user in the selected subject of neuropsychology. In this example, the segment 72 represents the core concept of biology, where the user still needs to learn more; a segment 73 represents a core concept of psychology, which also requires more learning; a segment 74 represents English and composition, where the user already has sufficient knowledge; and the segment 75 represents mathematics, where the user has insufficient knowledge. Of course, depending on the selected knowledge path, the segments 71-75 may represent different subjects and core concepts.

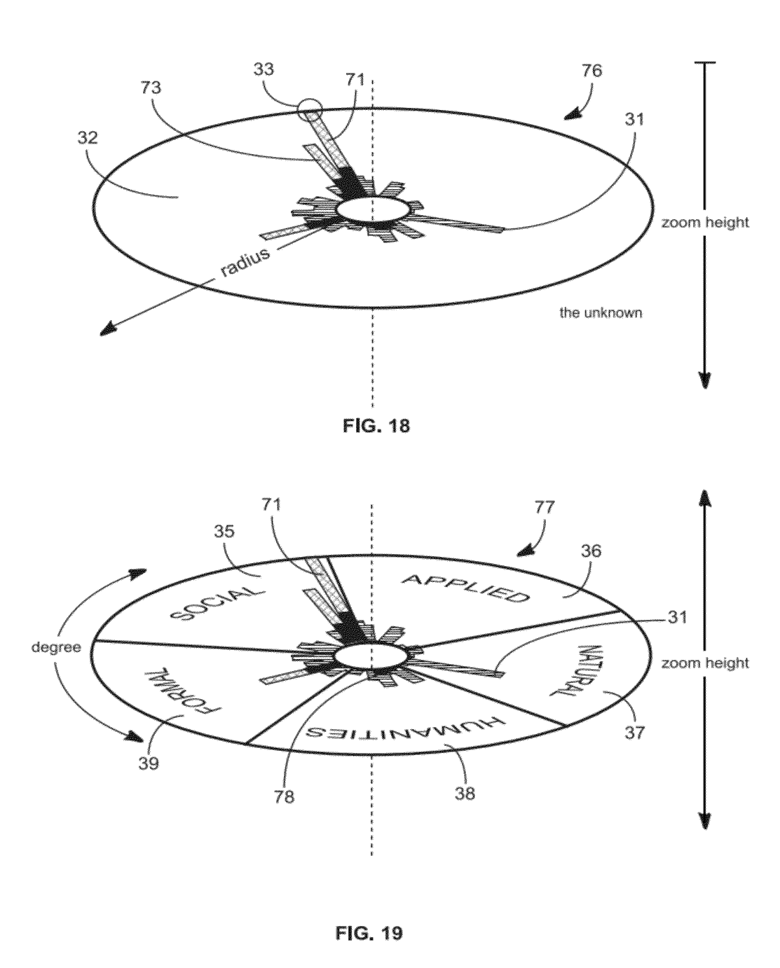

The software of the instant system can be used to zoom in and out of the knowledge horizon navigator. An optional step 76 illustrated in FIG. 18 shows the user zooming out at the highest altitude to compare his/her knowledge with the knowledge path of the personal curriculum in the selected subject of neuropsychology. Some of the required segments, such as segment 71 extend out to the knowledge horizon 33, where new knowledge relating to neuropsychology is being created, where experiments are conducted, where articles on discoveries are published in relevant scholarly journals.

The user can also zoom in using the knowledge horizon navigator to compare the user's knowledge with the knowledge path to the selected subject of neuropsychology. As shown in FIG. 19, the optional step 77 allows the user to determine in which of the five knowledge categories (social sciences, applied sciences, natural sciences, humanities and formal sciences) the user needs to acquire more knowledge. The light shaded areas in FIG. 19 represent the user's existing knowledge or knowledge profile; darker shaded areas 71 represent knowledge path (personal curriculum) to neuropsychology, while the darkest shaded areas 78 represent knowledge overlap.

Zooming in to a lower altitude allows the user to compare his knowledge profile to the computer-generated knowledge path in more detail. In the illustrative example of FIG. 19, the optional step 79 is shown. Here, the core knowledge category of formal sciences 39 is divided into three basic areas, each defined by a segment: computer science 39a, mathematics 39b, and system science 39c. When user's knowledge profile is overlaid with the required curriculum, the user can see the dark shaded areas 39g and 39h demonstrating that the user already has sufficient knowledge in computer science but is lacking in the subject of mathematics.

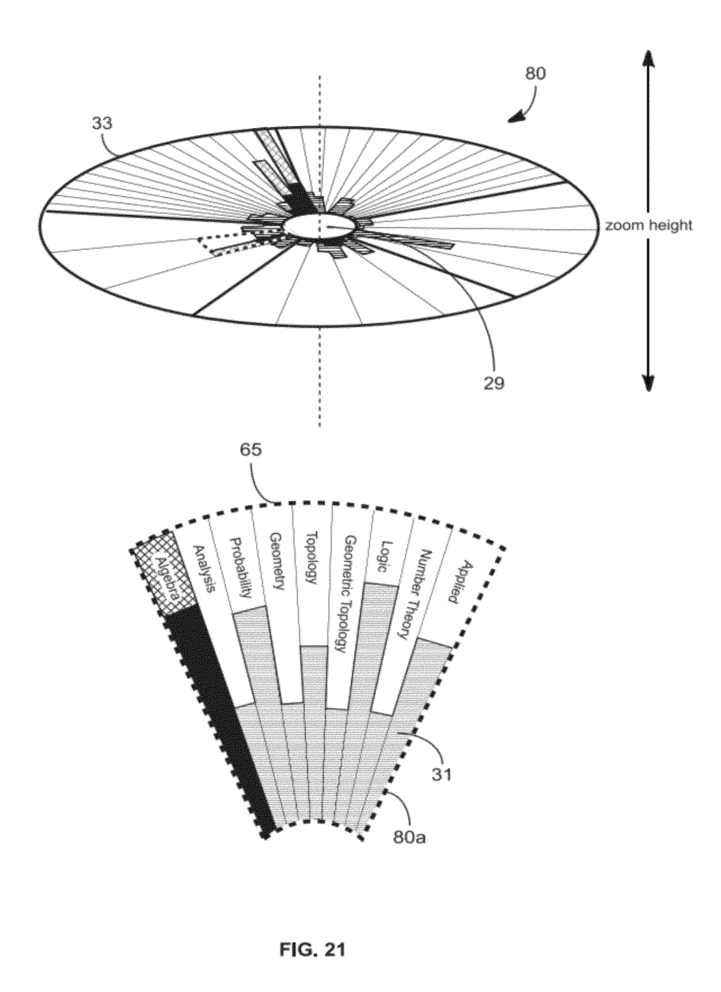

The user can also zoom into a still lower altitude level, where the knowledge area of mathematics is subdivided into its fundamental concepts. This optional step 80 is illustrated in FIG. 21. At this altitude, the fundamental concepts identified in the personal curriculum are shown closer to the center 29 of the knowledge horizon 33. The fundamental concept of mathematics is shown subdivided into more specific sub-concepts of algebra, geometry, analysis, topology, etc., as shown in detail in segment 80a. In the segment 80a, the user's knowledge profile 31 is overlaid over the required sub-concepts. Here, the user can see that the user needs to learn significantly more in the subject of algebra (segment 81) in order to understand neuropsychology.

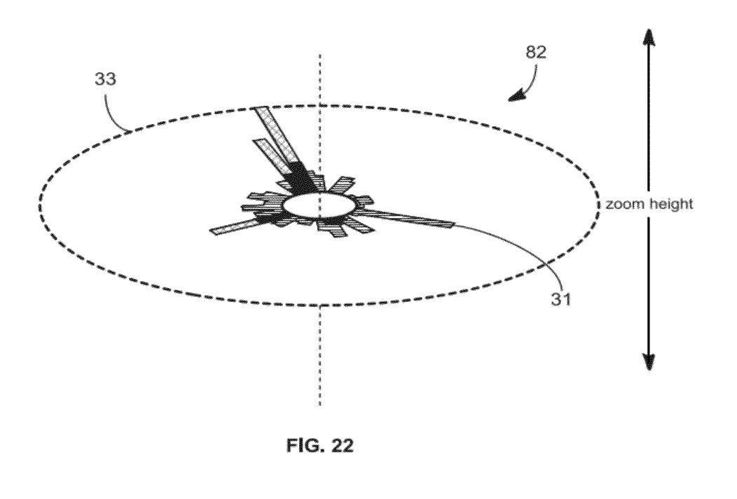

An optional step 82 illustrated in FIG. 22 allows the user to zoom in to n-level altitude comparing the user's computer-generated curriculum with the knowledge path to neuropsychology. Each of the overlapping shaded areas can be zoomed into in order to subdivide the concepts or sub-concepts into smaller segments of fundamental core concepts.

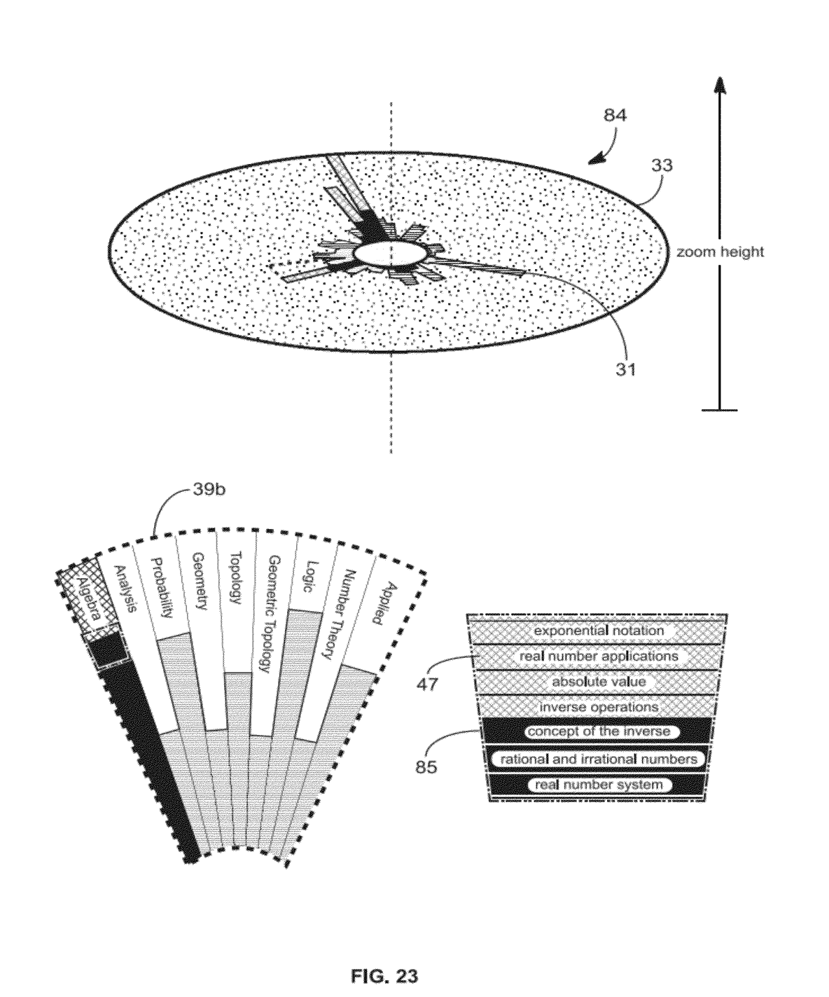

FIG. 23 illustrates a step 84, where the user zooms into the lowest altitude to compare the user's knowledge profile to the specific curriculum or knowledge path to neuropsychology. At this altitude, the user can see the fundamental core concepts organized hierarchically by core concepts; the user must master concept A before the user moves to study concept B or concept C, etc. In this example, the user's knowledge profile shows what core concepts the user knows and which he/she has not mastered as yet. The user cam see the core concepts on the knowledge path to neuropsychology and these core concepts overlap the knowledge profile created by the system. In the illustrated example, the user needs to learn inverse operations identified by numeral 85 in the table 47.

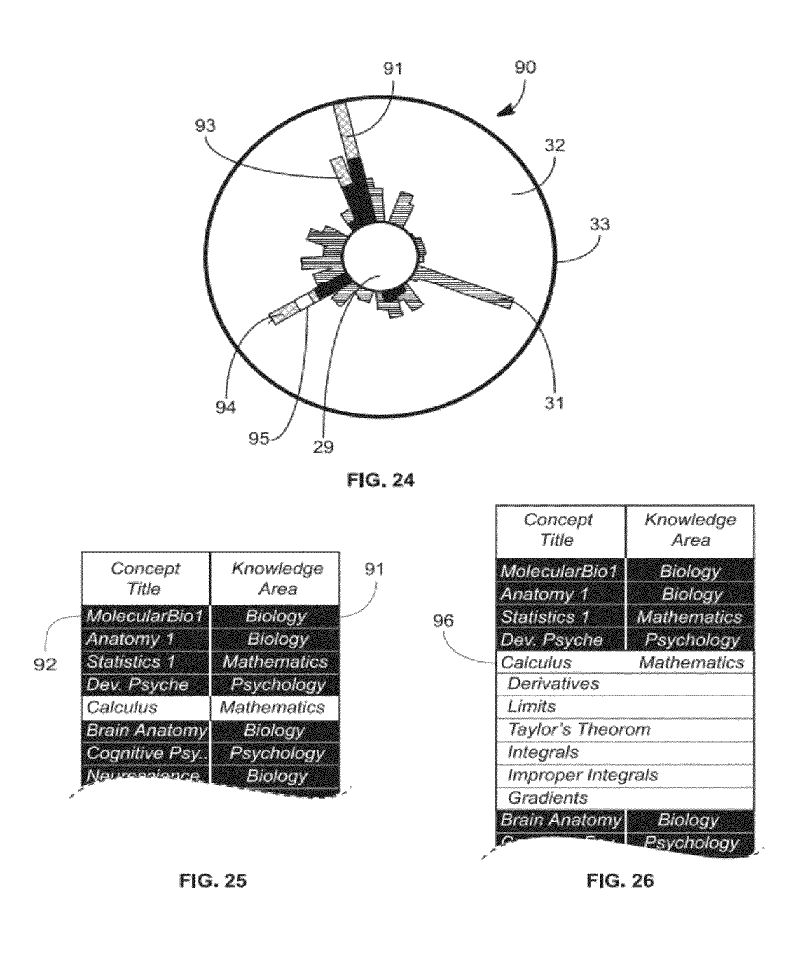

The system also allows the user to examine in detail the concepts and core concepts in the system-created knowledge path in order to understand a specific subject. The step 90 shown in FIG. 24 compares the user's knowledge profile relative to the knowledge path to the chosen subject, shown overlaid in the circle 32. The detail view of the segment 91 broken down into core concepts is shown in FIG. 25. In this example, the user can easily see that the first thing the user must learn is biology, identified as segment 91, a subject which is more important on the knowledge path to neuropsychology than other subjects. More specifically, the user must learn molecular biology identified by numeral 92 in the table of FIG. 25.

The other areas where the learning must concentrate are psychology, as identified by numeral 93 and mathematics, identified by numeral 94. When the user highlights a concept in either the graphical interface or in the incremental and hierarchical list of concepts interface, the concept is highlighted in both, as shown at 95 in FIG. 24.

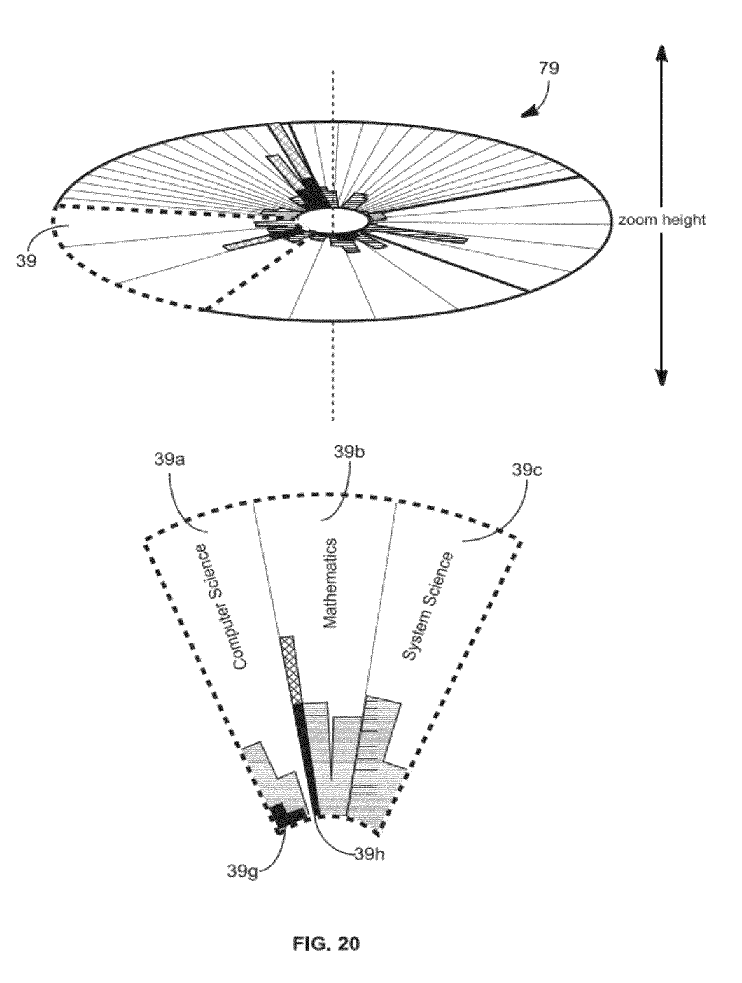

FIG. 26 illustrates incremental knowledge path from the user's current knowledge base to neuropsychology by concept titles. The table of FIG. 26 shows a concept of calculus identified by numeral 96 subdivided into sub-concepts, such as derivatives, limits, integrals, etc. As the user explores deeper into the knowledge areas within the knowledge path moving from knowledge area to concepts, then to cob-concepts, then to core concepts, the user can navigate within the graphical interface of FIGS. 18-23. The system-created images allow the user to work with the incremental and hierarchical lists of concepts interface, revealing the details of the personal curriculum created by the system.

The interactive system of the present invention provides for the use of a memory in the CPU 12 configured to store a large reference database structured around a plurality of academic subjects in its knowledge database. This reference source assigns a specific knowledge area its designated place in the collective knowledge base. The memory also stores at least one interactive module configured for interface between the user of the system and the reference database. The interactive module comprises a question set configured to allow the user to input the user's scope of academic topics the user had mastered through a formal or informal educational process. The interactive module monitors the user's responses and, based on the user's input in the question set, generates a profile corresponding to the knowledge of the user of the specific academic topics. The system creates a module of user's knowledge or knowledge profile that can be compared to a collective knowledge in a plurality of subjects and academic disciplines. The interactive module also allows the user to select, from a plurality of anonymous inputs of other system users, a knowledge profile of another person and compare the user's knowledge profile with that other person's knowledge profile.

The interactive module is further configured to generate a specific curriculum, or knowledge path based on the user's selection of a particular subject from the reference database. The interactive module comprises processing instructions for the interface between the user and the reference database, a selection command configured to select from the reference source a topic corresponding to the user's explicit interest in a specific academic area. This phase encompasses designing and implementing structures to effectively manage information or knowledge within the specific academic area.

A retrieval command is configured to retrieve a specific curriculum or knowledge path assigned to the specific academic area. The system assigns an objective hierarchical importance to a plurality of topics constituting the knowledge area as it relates to the specific curriculum. The processor 12 executes the interactive module, displaying on a display connected to the processor, the knowledge categories, core concepts, and sub-concepts for the user to acquire within the selected knowledge path. An input device operationally connected to the processor allows communication between the user and the processor.

The interactive module is configured to allow the user to compare the user's knowledge profile to the core concepts, sub-concepts and specific subjects needed to master the selected subject. The comparative result is displayed on the display, allowing the user to navigate between broad categories, concepts and narrow sub-concepts in the acquisition of knowledge in the knowledge path.

Many changes and modifications can be made in the system of the present invention. We, therefore, pray that our rights to the present invention be limited only by the scope of the appended claims.

We claim:

1. A method of knowledge assessment comprising the steps of:
providing a central processor having means for communicating via communication network, for displaying assessment queries to at least one user, a means for inputting responses to the assessment queries by said at least one user, and at least one user to communicate via said communication network;
providing a storage means for storing knowledge database in a variety of academic subjects;
transmitting via said communication network to said at least one user a plurality of assessment queries derived from said knowledge database, each of said queries being answerable based on said at least one user's previously acquired knowledge in one or more academic subjects;
receiving via the inputting means answers to the assessment queries;
generating a knowledge profile of said at least one user based on the user's answers to the assessment queries; and
creating a graphical image of the knowledge profile of said at least one user in the context of the knowledge database.

2. The method of claim 1, further comprising a step of transmitting via said communication network to said at least one user a specific query related to a selected academic subject, which said at least one user desires to learn and receiving via the inputting means an answer to the specific query.

3. The method of claim 2, further comprising a step of generating a detail curriculum in the selected academic subject based on the answer to the specific query by said at least one user.

4. The method of claim 2, further comprising a step of generating a detail curriculum in the selected academic subject based on the answers made by said at least one user to the assessment queries and the specific query.

5. The method of claim 2, further comprising a step of generating a detail curriculum in the selected academic subject based on the knowledge profile of said at least one user and the answer to the selected query.

6. The method of claim 2, further comprising a step of generating a detail curriculum based on the knowledge profile of the user in the selected academic subject and arranging the detail curriculum in a hierarchical manner.

7. The method of claim 1, wherein the steps of transmitting to said at least one user a plurality of assessment queries and of receiving answers to the assessment queries are both implemented via a microprocessor based computing device or a networked client-server communication system.

8. The method of claim 1, further comprising a step of generating individual knowledge profiles for a plurality of users and creating a database of knowledge profiles for each of said plurality of users.

9. The method of claim 8, further comprising a step of comparing the knowledge profile of said at least one user and knowledge profile of another user selected from said database of knowledge profiles.

10. The method of claim 9, wherein said step of comparing the knowledge profile comprises a step of providing an interactive module configured to be accessed by said at least one user via the communication network to allow said at least one user to select a knowledge profile from the database of knowledge profiles.

11. The method of claim 1, wherein said knowledge base is comprised of multiple user-generated learning modules.

12. A computer program product encoded in a non-transitory computer-readable information storage medium comprising:
computer-executable program code for defining a knowledge database in a plurality of academic subjects and a plurality of knowledge assessment queries comprising questions in the plurality of academic subjects, said product being usable with a programmable computer processor to assess a user's knowledge in the academic subjects, generating a user's knowledge profile based on the user's answers to the knowledge assessment queries and creating a graphical image of the user's knowledge profile in the context of the knowledge database, wherein the programmable computer processor is disposed in a computing device capable of displaying information on an interconnected information display device and capable of communicating, through an interconnected data input device, with a plurality of users via a communication network.

13. The product of claim 12, wherein the program code causes the programmable computer processor to compare the user's knowledge profile to collective knowledge contained in said knowledge database.

14. The product of claim 12, wherein the program code is configured to receive via the communication network an input from at least one user containing a specific query related to a designated academic subject, which said at least one user desires to learn.

15. The product of claim 14, wherein the program code is capable of creating a detail curriculum based on the knowledge profile of said at least one user and the specific query related to the designated academic subject.

16. The product of claim 15, wherein the program code is capable of arranging the detail curriculum in a hierarchical manner from broad to narrow subject categories and concepts.

17. The product of claim 12, wherein the program code causes the programmable computer processor to selectively compare knowledge profile of one user to knowledge profile of another user within the context of collective knowledge database.

18. The product of claim 12, wherein said knowledge database is comprised of user-generated learning modules .

19. A system for knowledge assessment adaptable for use in a processor based computing device and in a networked communication environment, the system comprising:
a programmable computer processor;
in input device capable of communicating with the processor via a communication network;
a display device operationally connected to the processor and the input device;
a group of databases comprising knowledge database and assessment queries related to a plurality of academic subjects stored and retrievable in the processor;
a query builder configured to construct a set of queries to be answered by said at least one user based on said at least one user's education in one or more academic subjects;
a knowledge profile creator configured to create knowledge profile of at least one user using answers by said at least one user to the questions constructed by the query builder; and
a visual image creator configured to create a graphic image of the knowledge profile of said at least one user within the context of the knowledge database.

20. The system of claim 19, further comprising a knowledge path creator configured to create a detail curriculum in a specific academic subject based on the responses to assessment queries made by said at least one user.

21. The system of claim 20, wherein the knowledge path creator is capable of arranging the detail curriculum in a hierarchical manner from broad to narrow subject categories and concepts.

22. The system of claim 19, wherein said knowledge path creator is configured to compare knowledge profile of said at least one user with knowledge profiles of other users.

23. The system of claim 22, wherein the visual image creator is capable of generating a comparative image of the knowledge profile of said at least one user with the knowledge profile of one or more other users.

24. The system of claim 20, further comprising an assessment module configured to compare said at least one user's knowledge profile to knowledge categories, sub-concepts and specific subjects needed to master the specific academic subject.

25. The system of claim 24, wherein said visual image creator further comprises an image builder configured to display on the display device navigational tools allowing said at least one user to navigate between broad knowledge categories, concepts and narrow sub-concepts in the acquisition of knowledge in the specific curriculum.

26. The system of claim 19, wherein said group of databases are comprised of user-generated learning modules.

27. A system of knowledge assessment comprises:
a programmable processor having an interconnected memory storage means for storing a reference knowledge database structured around a plurality of academic subjects, said knowledge database being divided into major categories including social sciences, applied sciences, natural sciences, humanities and formal sciences, said memory storage means further comprising at least one interactive module configured for interface between at least one user of the system and the reference knowledge database;
a query builder associated with the interactive module for constructing a set of queries to be answered by said at least one user based on said at least one user's education in one or more academic subjects;
a profile builder associated with the interactive module for creating knowledge profile of said at least one user based on responses to the set of queries answered by said at least one user;
a knowledge profile comparison module associated with the interactive module for comparing knowledge profile of the at least one user with a knowledge profile of another anonymous user of the system; and
a curriculum builder associated with the interactive module for developing a specific curriculum for said at least one user based on said at least one user's response to a specific query related to a user-selected academic subject.

28. The system of claim 27, wherein said interactive module comprises processing instructions for interface between said at least one user and the reference knowledge database, a selection command configured to select from the reference knowledge database a topic corresponding to said at least one user's explicit interest in a specific academic area.

29. The system of claim 28, wherein said interactive module further comprises a retrieval command builder configured to retrieve a specific curriculum assigned to the specific academic area.

30. The system of claim 27, wherein the interactive module is configured to assign an objective hierarchical importance to a plurality of topics constituting the reference knowledge area as it relates to the specific curriculum.

31. The system of claim 27, wherein the programmable computer processor is disposed in a computing device capable of displaying information on an interconnected information display device and capable of communicating, through an interconnected data input device, with a plurality of users via a communication network.

32. The system of claim 31, wherein the interactive module is configured to display on a display connected to the processor, the knowledge categories, core concepts, and sub-concepts for said at least one user to acquire within the selected knowledge path.

33. The system of claim 32, further comprising an assessment module configured to compare said at least one user's knowledge profile to the knowledge categories, sub-concepts and specific subjects needed to master the specific academic subject.

34. The system of claim 32, further comprising an image builder configured to display on the interconnected display navigational tools allowing said at least one user to navigate between broad knowledge categories, concepts and narrow sub-concepts in the acquisition of knowledge in the specific curriculum.
